(19) United States
(12) Patent Application Publication
(10) Pub. No.: US 2012/0206762 A1
(43) Pub. Date: Aug. 16, 2012

(54) INFORMATION PROCESSING DEVICE, PRINTING METHOD, AND STORAGE MEDIUM

(75) Inventor: Tomonori Minagawa, Yokohama-shi (JP)

(73) Assignee: CANON KABUSHIKI KAISHA, Tokyo (JP)

(21) Appl. No.: 13/364,113

(22) Filed: Feb. 1, 2012

(30) Foreign Application Priority Data
Feb. 16, 2011 (JP) 2011-031243

(51) Int. Cl. G06F 3/12

(52) U.S. Cl. 358/1.15

(57) ABSTRACT

An information processing device stores setting information and process information in a storage device in association with a setting button. The setting information indicates the setting values of print setting items specified in response to a user operation. The process information indicates a process assigned in response to a user's operation among a plurality of processes, which may be performed during printing. The information processing device updates setting information to be used in the printing with the setting information associated with a user interface, and performs the process assigned to the process information associated with the user interface, in response to a user's operation of the setting button.

### BACKGROUND OF THE INVENTION

1. Field of the Invention

The present invention relates to an information processing device, printing method, and storage medium.

2. Description of the Related Art

In general, an information processing device allows the user to specify the setting values of various setting items via the user interface. Some information processing devices provide the user with the function to register several setting items at a time and to enable the user to select these setting items to change the setting values of multiple setting items at a time, especially when there are many setting items that have a complex dependency relation.

For example, a printer driver provides “Collective Setting” or “Favorite” used to collectively change the setting values, such as the output paper size and layout, finishing, output destination, paper input bin, and quality setting. The printer driver also provides “Subset Change” or “Override Change” that allows the user to collectively change only the desired items of those settings (See Japanese Patent Application Laid-Open No. 2000-112683).

However, the method discussed in Japanese Patent Application Laid-Open No. 2000-112683 requires the user to press the “OK” button last time for any change, in other words, to perform at least two steps, “Add change+Press OK”, possibly making the user feel the operation inconvenient. A frequently performed function such as “Reset to Initial Values” also requires the user to perform two actions, “Reset to Initial Value+Press OK”, possibly making the user feel the operation inconvenient.

### SUMMARY OF THE INVENTION

The present invention is directed to change the setting values of print setting items more easily.

An information processing device of the present invention is an information processing device that has a storage device. The information processing device comprises a storing unit configured to store setting information and process information in the storage device in association with a setting button, the setting information indicating setting values of print setting items specified in response to a user operation, and the process information indicating a process assigned in response to the user's operation among a plurality of processes which may be performed during printing; and an execution unit configured to update setting information to be used in the printing with the setting information associated with the setting button and, to perform the process assigned to the process information associated with the setting button, in response to the user's operation of the setting button.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an example of the configuration of a print system.

FIG. 2 is a diagram illustrating an example of the hardware configuration of a host computer and a printer.

FIG. 3 is a diagram illustrating an example of the configuration of the host computer.

FIG. 4 is a diagram illustrating an example of the User Interface (UI).

FIG. 5 is a diagram illustrating an example of the flowchart of the print control processing.

FIG. 6 is a diagram illustrating an example of the UI.

FIG. 7 is a diagram illustrating an example of collective setting information.

FIGS. 8A and 8B are diagrams illustrating an example of the UI.

FIGS. 9A and 9B are diagrams illustrating an example of the UI.

FIGS. 10A, 10B, and 10C are diagrams illustrating an example of the UI.

FIG. 11 is a diagram illustrating an example of the flowchart of the print control processing.

FIG. 12 is a diagram illustrating an example of the flowchart of the print control processing.

FIGS. 13A, 13B, and 13C are diagrams illustrating an example of the UI.

FIG. 14 is a diagram illustrating an example of the flowchart of the print control processing.

FIG. 15 is a diagram illustrating an example of the UI.

### DESCRIPTION OF THE EMBODIMENTS

Various exemplary embodiments, features, and aspects of the invention will be described in detail below with reference to the drawings.

Note that exemplary embodiments do not limit the present invention and that not all components described in the exemplary embodiments are always required as units for solving the problems of the present invention.

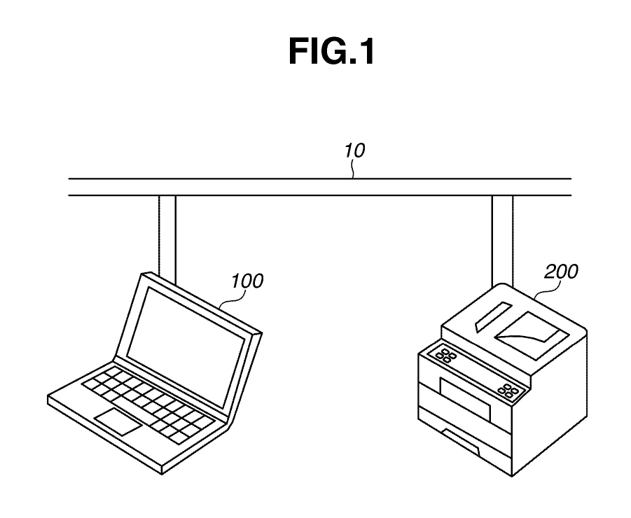

FIG. 1 is a diagram illustrating an example of the configuration of a print system in a first exemplary embodiment. This print system includes a host computer 100 and a printer 200. The host computer 100 and the printer 200 are connected communicably over a network 10.

The present exemplary embodiment may be implemented by a configuration composed of either a standalone apparatus or a system of multiple apparatuses. The present exemplary embodiment may be implemented by either a local connection or a system having a network such as a Local Area Network (LAN) or Wide Area Network (WAN).

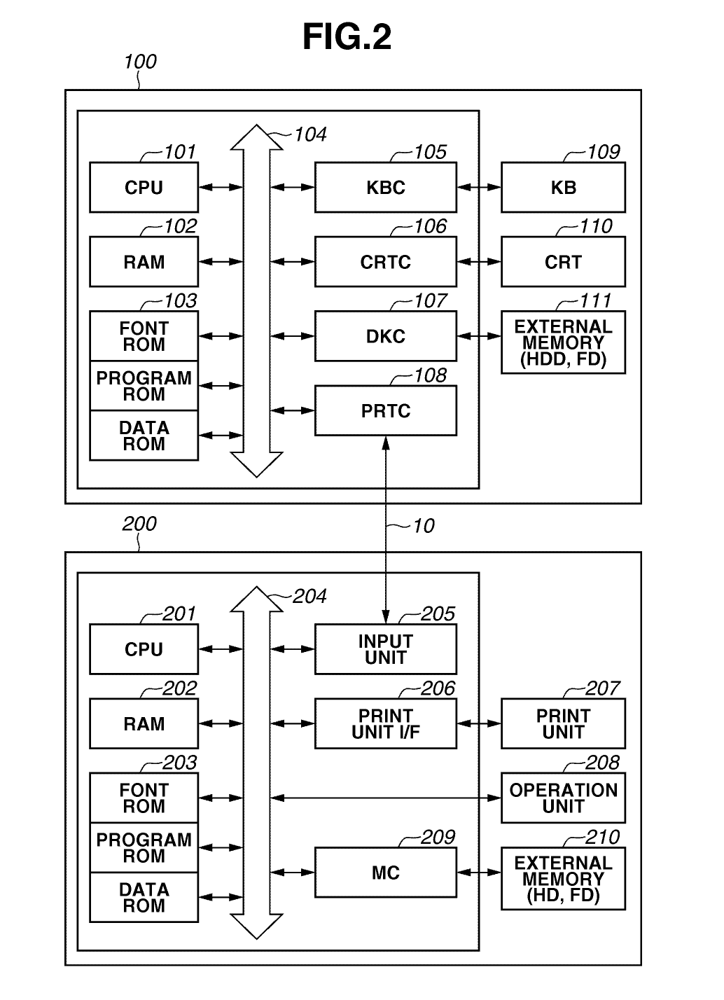

FIG. 2 is a diagram illustrating an example of the hardware configuration of the host computer 100 and an example of the hardware configuration of the printer 200.

The host computer 100, an example of an information processing device (computer), has multiple devices. The devices connected to a system bus 104 are controlled integrally by a Central Processing Unit (CPU) 101. The CPU 101 processes a document and an image based on the document processing program stored in the program Read Only Memory (ROM) of a ROM 103 or an external memory 111. A Random Access Memory (RAM) 102 functions as the main memory and the work area of the CPU 101. The program ROM of the ROM 103 or the external memory 111 stores the Operating System (OS), the control program of the CPU 101. The font ROM of the ROM 103 or the external memory 111 stores font data used for the document processing of the document processing program. The data ROM of the ROM 103 or the external memory 111 stores various types of data used for the document processing.

A Keyboard Controller (KBC) 105 controls the key input from a Keyboard (KB) 109 and a pointing device (an example of input device) not shown. A Cathode Ray Tube Controller (CRTC) 106 controls the display of a CRT display (CRT) 110, an example of a display device. A Disk Controller (DKC) 107 controls access to and from the external memory 111 that stores the boot program, various types of application programs, font data, and printer driver program.

A Printer Controller (PRTC) 108 connects the host computer 100 to the printer 200 via the network 10, which acts as an example of the bidirectional interface, to perform the communication control with the printer 200. The external memory 111, an example of a storage device, is a Hard Disk Drive (HDD) or a Flexible Disk (FD).

The CPU 101 performs the outline font expansion (rasterize) processing into the display information RAM provided in the RAM 102 to enable WYSIWYG on the CRT 110.

The CPU 101 also opens various windows, registered based on the commands specified by the mouse cursor, (not shown) on the CRT 110, to perform various types of data processing. When various applications perform printing, the CPU 101 starts the printer driver. For example, the printer driver opens a print window in response to a user operation on the input device (user operation) and, via this window, receives the print processing method instructions such as a printer specification and a print mode selection.

In this exemplary embodiment, the CPU 101 performs processing according to the program procedure, stored in the external memory 111, to implement the function on the host computer 100 and the processing of the flowchart.

The printer 200, an example of a print device (computer), is controlled by a CPU 201. The CPU 201 performs operation based on the control program, stored in the program ROM of a ROM 203 or the control program stored in an external memory 210. The CPU 201 outputs the image signal, which is the output information, to a print unit (printer engine) 207 connected to a print unit interface (IF) 206, via a system bus 204.

The program ROM of the ROM 203 stores the control program of the CPU 201. The font ROM of the ROM 203 stores font data used for generating output information. When a printer has no external memory 210 such as a hard disk, the data ROM of the ROM 203 stores information used by the host computer 100.

The CPU 201, capable of communicating with the host computer 100 via an input unit 205, can notify information on the printer 200 to the host computer 100. A RAM 202, which functions as the main memory and the work area of the CPU 201, is configured so that the memory capacity can be increased by adding an option RAM, which is attached to an expansion port (not shown). The RAM 202 is used as an output information expansion area, an environment data storage area, and a Non-Volatile Random Access Memory (NVRAM).

The external memory 210 is a hard disk (HDD) or an Integrated Circuit (IC) card, and the access to the external memory 210 is controlled by a Memory Controller (MC) 209. The optionally connected external memory 210 stores font data, an emulation program, and form data. The switches and the Light Emitting Diode (LED) indicators for an operation on the operation panel are connected to the input unit 205.

Not one but a plurality of external memories 210 may be provided on the printer 200. The printer 200 may also be configured so that a plurality of external memories (e.g., an option card) that store a program which interprets different printer control language, in addition to built-in font. In addition, the printer 200 may have an NVRAM (not shown) to store setting information such as the printer mode received from an operation unit 208 such as the operation panel.

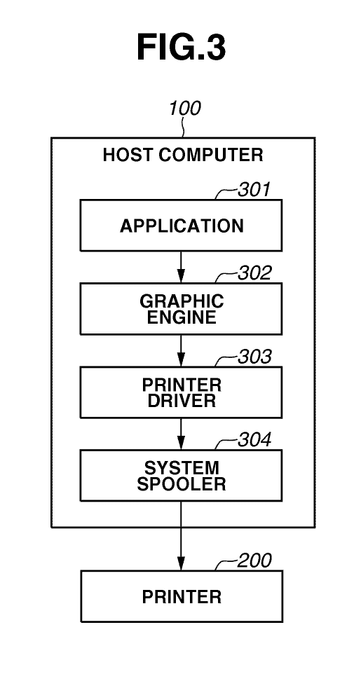

FIG. 3 is a diagram illustrating an example of the configuration of the host computer 100. A print device such as the printer 200 is connected to the host computer 100 directly or via a network.

The host computer 100 includes the modules such as an application 301, a graphic engine 302, a printer driver 303, and a system spooler 304. These modules are implemented when one or more programs, stored in the external memory 111, are loaded into the RAM 102 by the Operating System (OS) or by some other module that uses a module, and executed.

The programs of the application 301 and the printer driver 303 may be added to an HDD, which is one of the external memories 111, by use of a Floppy Disk (FD) or a Compact Disk Read Only Memory (CD-ROM) (not shown) or via a network (not shown).

When printing is carried out by the printer 200, the application 301 uses the graphic engine 302 loaded in the RAM 102, to output (draw) data.

The graphic engine 302 reads the program of the printer driver 303 prepared for each printer, from the external memory 111, loads the printer driver 303 into the RAM 102, and sets the output received from the application 301, to the printer driver 303. After that, the graphic engine 302 converts the data from the Graphic Device Interface (GDI) function (output data) received from the application 301, to the print format data interpretable by the Device Driver Interface (DDI) function or the XML Paper Specification (XPS), and outputs the converted data to the printer driver 303.

A sequence of data the printer driver 303 receives is referred to as a print job or simply a job. One print job is created for each print request.

The printer driver 303 converts the print format data to control commands recognizable by the printer 200, for example, to Page Description Language (PDL), based on the print job received from the graphic engine 302. In the description below, a set of control commands generated from one print request is referred to as an output job. The generated output job is output to the printer 200 as print data via the system spooler 304 loaded into the RAM 102 by the OS.

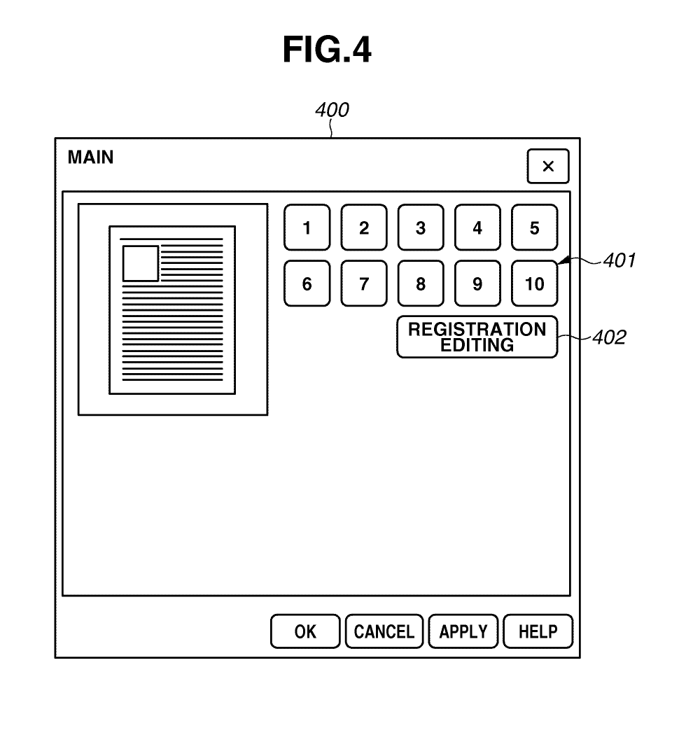

FIG. 4 is a diagram illustrating an example (main screen 400) of the UI (User interface) for specifying the setting values of the setting items for printing. The main screen 400 is displayed on the CRT 110.

For example, when the user presses any one of the Collective Setting buttons 401, the printer driver 303 collectively changes the setting values of the print setting items according to the setting values registered for the pressed Collective Setting button 401. When the user presses a Registration Editing button 402, the printer driver 303 performs control to display another screen (for example, registration editing screen that will be described later) on the CRT 110 to allow the user to change the setting values of print setting items associated with each Collective Setting button. Although a push button is shown as the UI, a bit-mapped button or another input-form UI may also be used.

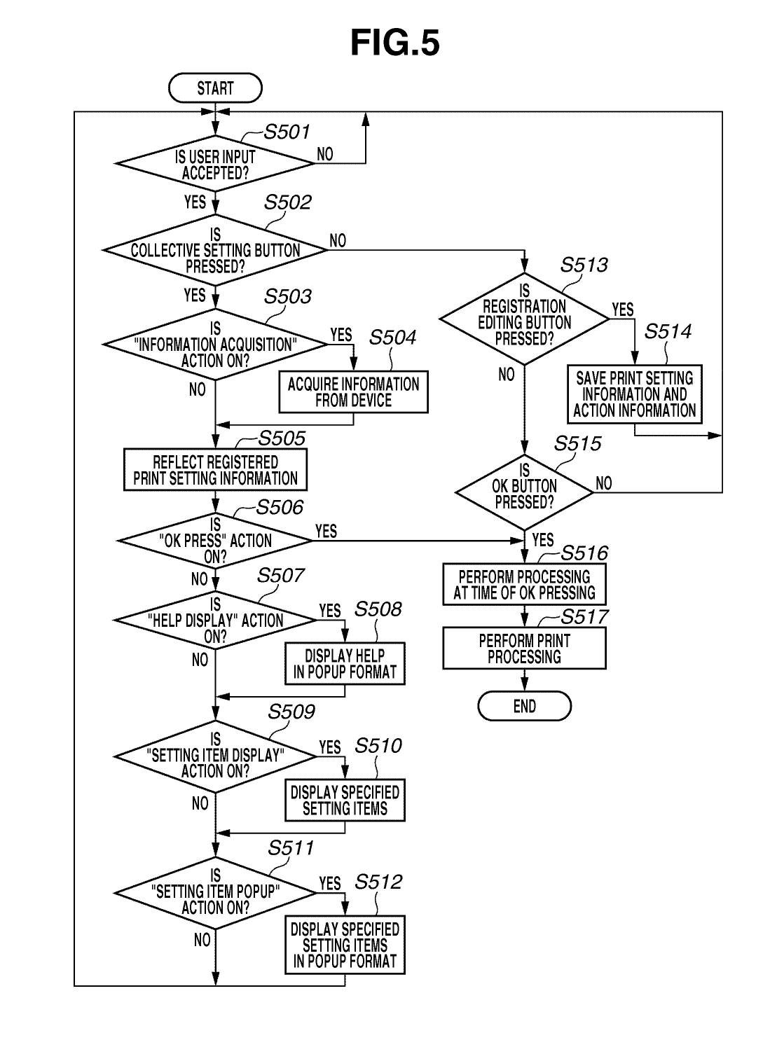

FIG. 5 is a diagram illustrating an example of the flowchart of the print control processing performed by the printer driver 303. The flowchart of the present application is implemented by the CPU 101 reading and executing the related program.

First, in step S501, the printer driver 303 determines if an input is received from the user. If an input is received (YES in step S501), the printer driver 303 performs the processing in step S502. On the other hand, if an input is not received (NO in step S501), the printer driver 303 performs the processing in step S501.

In step S502, the printer driver 303 determines if the input was made by pressing a Collective Setting button. If the input was made by pressing a Collective Setting button (YES in step S502), the printer driver 303 performs the processing in step S503. On the other hand, if the input was not made by pressing a Collective Setting button (NO in step S502), the printer driver 303 performs the processing in step S513.

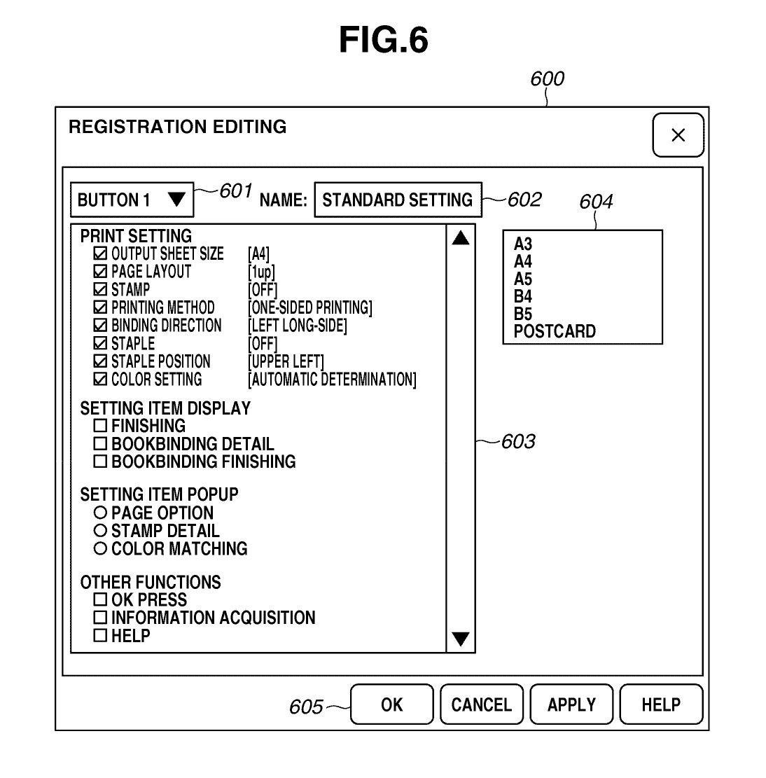

In step S513, the printer driver 303 determines if the Registration Editing button is pressed. If the Registration Editing button is pressed (YES in step S513), the printer driver 303 performs the processing in step S514. On the other hand, if the Registration Editing button is not pressed (NO in step S513), the printer driver 303 performs the processing in step S515. In step S514, the printer driver 303 associates the print setting information (an example of setting information) and action information (an example of process information) with a Collective Setting button (number button) via the UI such as that shown in FIG. 6 and saves the information in the external memory 111. The print setting information is composed of the setting values of multiple items.

FIG. 6 is a diagram illustrating an example of the UI (Registration Editing screen 600) for assigning the processing (action), which may be performed at the time of printing, to a Collective Setting button in response to the user operation. On the Registration Editing screen 600, the user can use a list box 601 to specify (select) a Collective Setting button of items to be assigned. On the Registration Editing screen 600, the user can enter a name, which is to be associated with the specified (selected) Collective Setting button, in a text box 602 and specify the print setting information and actions from an assignment area 603.

To generate the print setting information, the user selects (turns on a checkbox) a setting item, whose setting value is to be changed when the Collective Setting button is pressed, from the assignment area 603 and selects the setting value of the setting item from the options displayed in an input area 604 (list box in this example).

In addition, an action (“Setting item display”, “Setting item popup”, “OK press”, “Information acquisition”, “Help”) is assigned to the Collective Setting button, so that the action assigned to the button, is executed when the Collective Setting button is pressed.

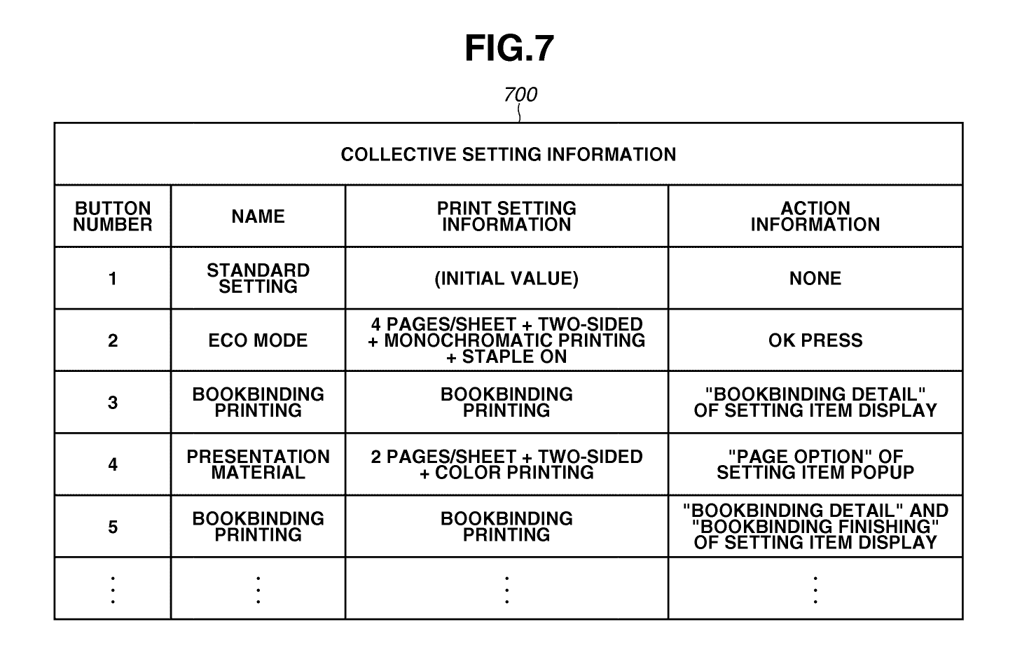

When the user presses an OK button 605 to determine the setting values of the print setting items, the collective setting information, which includes the name, print setting information, and action information, is stored in the external memory 111 as shown in FIG. 7.

In step S503, the printer driver 303 determines if the “Information acquisition” action is ON in the action information of the collective setting information which is associated with the Collective Setting button pressed in step S502.

If the “Information acquisition” action is ON (YES in step S503), the printer driver 303 acquires the information from the device such as the printer 200 in step S504 and then performs the processing in step S505. The information acquired in this step is an example of determination information used to check (determine) the compatibility with the print setting information. On the other hand, if the “Information acquisition” action is OFF (NO in step S503), the printer driver 303 performs the processing in step S505.

In step S505, the printer driver 303 reflects the print setting information of the collective setting information corresponding to the Collective Setting button pressed in step S502, on the current print setting information. At this time, the printer driver 303 sets the setting values of the print setting information corresponding to the Collective Setting button pressed in step S502, to the setting items whose checkboxes are turned ON in FIG. 6.

In step S506, the printer driver 303 determines if the “OK press” action is ON. In this step, if “OK press” is ON, the printer driver 303 performs the processing in step S516 to internally perform the processing similar to the one performed when the user presses the OK button. After that, the printer driver 303 performs the processing in step S517 and then terminates the processing. For example, in step S516, the printer driver 303 closes the print UI (an example of determined execution processing). In step S517, the printer driver 303 performs a sequence of print processing in which print data is generated and transmitted to the printer 200.

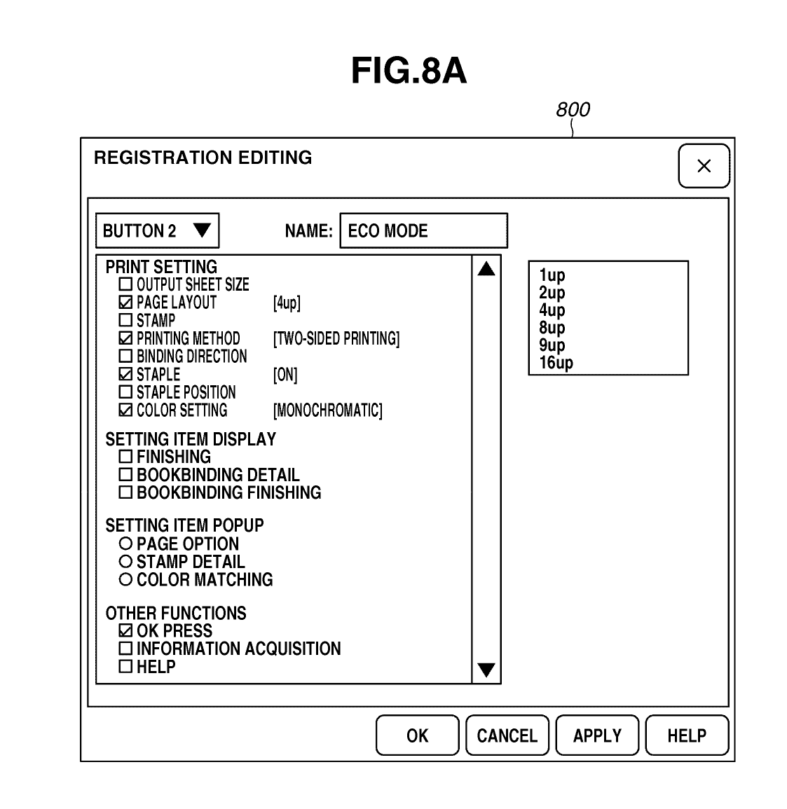

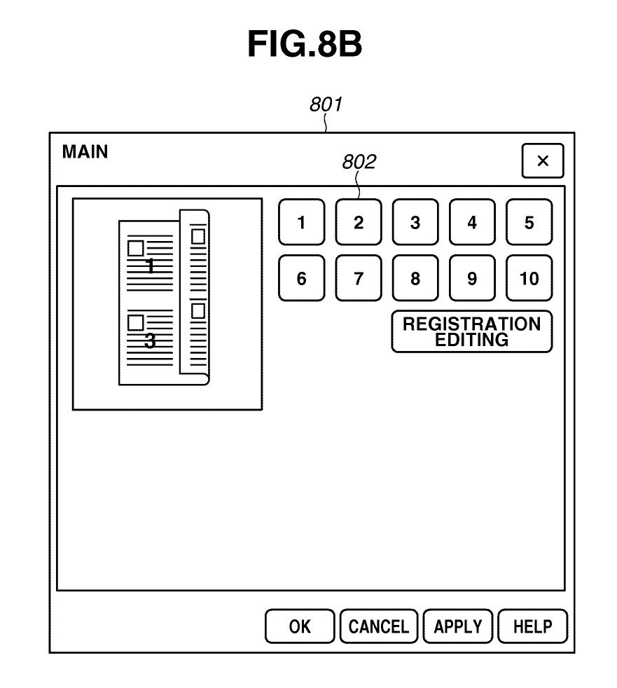

Referring to FIG. 8, the following describes the above-described processing more in detail. FIGS. 8A and 8B are diagrams illustrating an example of the UI. FIG. 8A is a diagram illustrating an example of a registration editing screen 800 on which “4 pages/sheet”, “Two-sided printing”, “Staple ON”, and “Monochromatic printing” of the print setting information and “OK press” of the action information are assigned to the Collective Setting button 2.

When the user presses the Collective Setting button 2 (802) on a main screen 801 shown in FIG. 8B after registering the settings shown in FIG. 8A in step S514, the printer driver 303 sets “4 pages/sheet”, “Two-sided printing”, “Staple ON”, and “Monochromatic printing” in the related setting items in step S505. In addition, the “OK press” action assigned to the Collective Setting button 2 (802) is carried out, and the setting values of the print setting items are determined and the main screen 801 is closed in step S516. After that, the printer driver 303 generates print data based on the setting values that have been set and transmits the generated print data to the printer 200. As described above, since the “OK press” action is assigned to the Collective Setting button, the user can change and determine the print setting information with one click.

On the other hand, if the “OK press” action is OFF in step S506 (NO in step S506), the printer driver 303 performs the processing in step S507. In step S507, the printer driver 303 determines if the “Help display” action is ON. If the “Help display” action is ON (YES in step S507), the printer driver 303 displays the help in the popup format on the CRT 110 in step S508 and then performs the processing in step S509. A help screen displayed in step S508 is, for example, the top page of the help screen. Another help screen is a screen related to the print setting information that is set on the pressed Collective Setting button. A still another help screen is a screen related to “Setting item display” and “Setting item popup” that are set on the pressed Collective Setting button. On the other hand, if the “Help display” action is OFF (NO in step S507), the printer driver 303 performs the processing in step S509.

In step S509, the printer driver 303 determines if any one of the “Setting item display” actions is ON. If any one of the items is ON (YES in step S509), the printer driver 303 displays the setting screen on the current screen in step S510 to allow the user to set the setting values of the specified setting items.

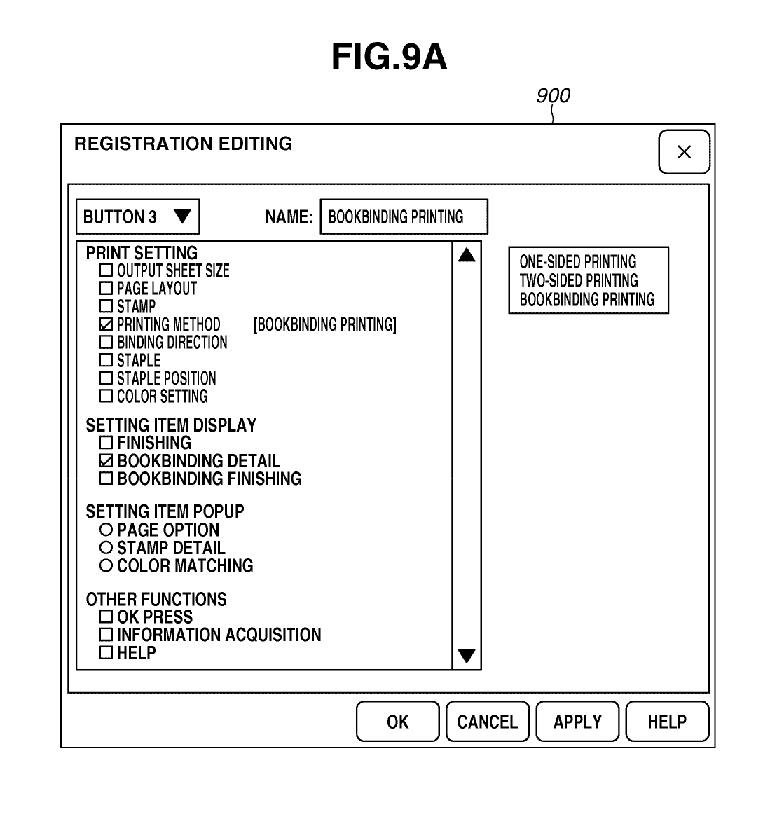

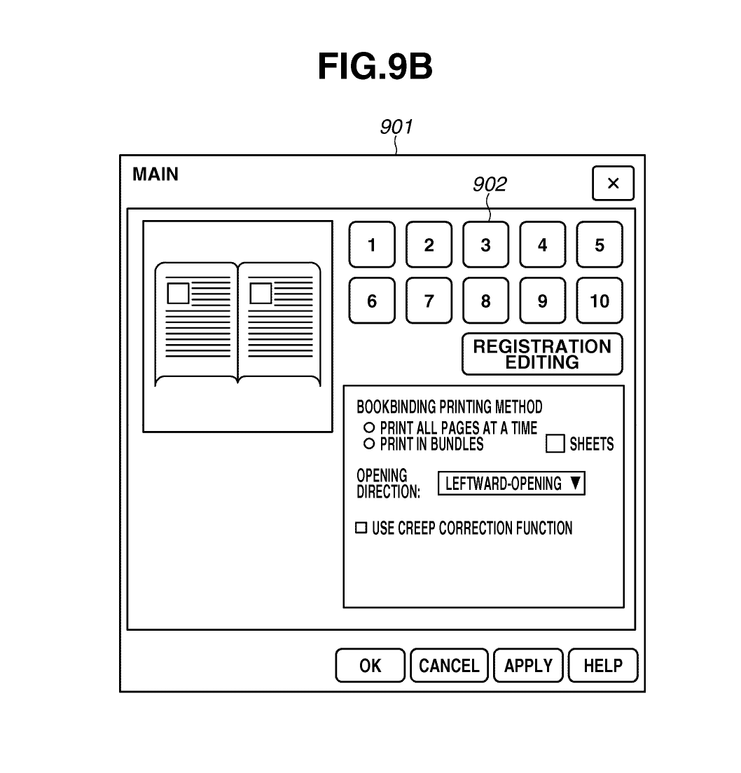

Referring to FIG. 9, the following describes the above-described processing more in detail. FIGS. 9A and 9B are diagrams illustrating an example of the UI. FIG. 9A is a diagram illustrating an example of a registration editing screen 900 on which “Bookbinding printing” of the print setting information and “Bookbinding detail” of Setting Item Display of the action information are assigned to the Collective Setting button 3.

In this case, when the user presses a Collective Setting button 3 (902) on a main screen 901 shown in FIG. 9B after registering the settings shown in FIG. 9A, in step S514, the related setting items are overwritten by “Bookbinding printing” in step S505. In addition, because the “Setting item display” action assigned to the Collective Setting button 3 (902) is ON, the setting screen is displayed on the main screen 901 in step S510 to allow the user to set the setting values in the setting items of “Bookbinding detail”.

The setting value of each setting item is displayed as one display item or as a combination of multiple display items. In the example in FIG. 9B, the screen of the setting item “Bookbinding detail” is composed of a combination of three display items, “Bookbinding printing method”, “Opening direction”, and “Use creep correction function”. In some cases, multiple setting items are specified for the “Setting item display” action. In that case, the printer driver 303 displays the screen that includes the multiple specified setting items.

In step S511, the printer driver 303 determines if any one of the “Setting item popup” actions is ON. If any one of the “Setting item popup” actions is ON, the printer driver 303 displays the setting screen of the specified setting items on the CRT 110 in the popup format in step S512 and then performs the processing in step S501.

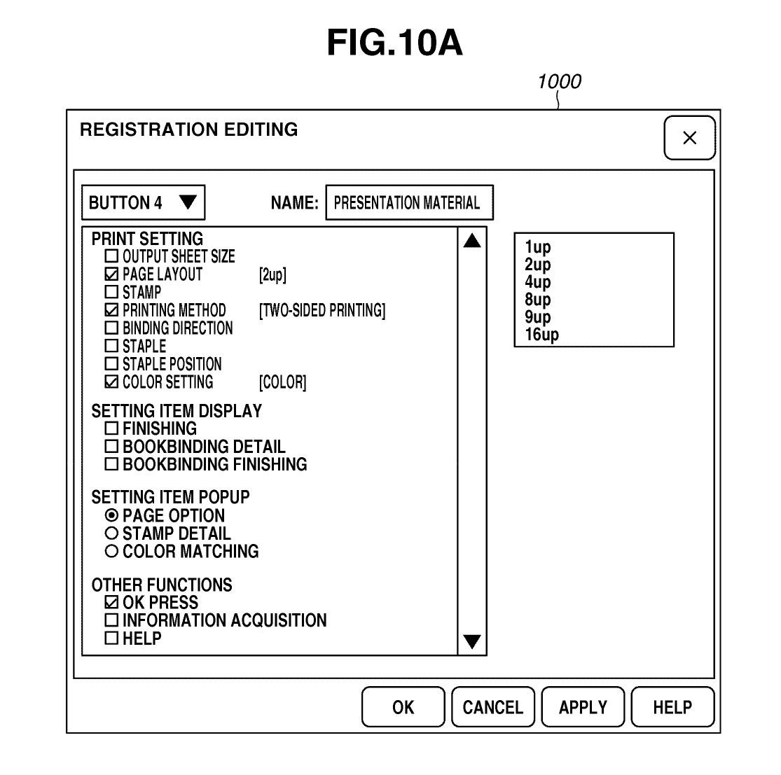

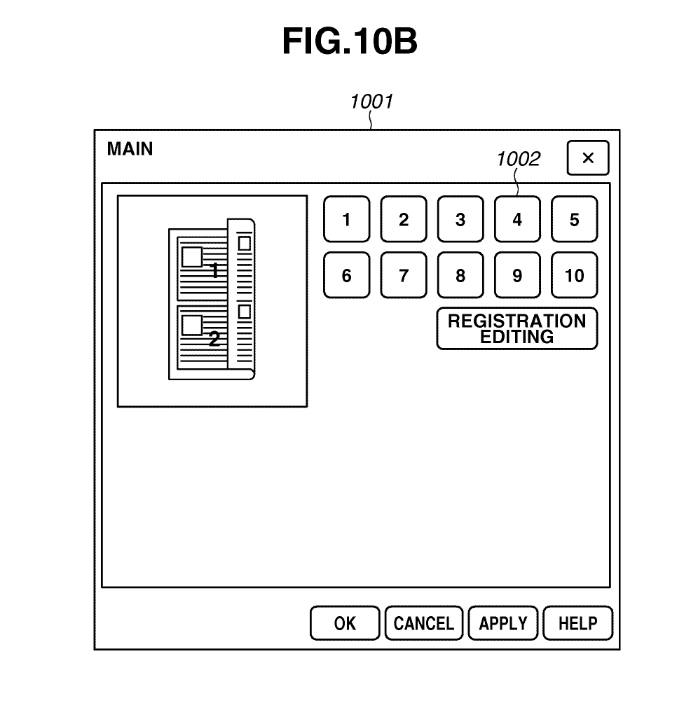

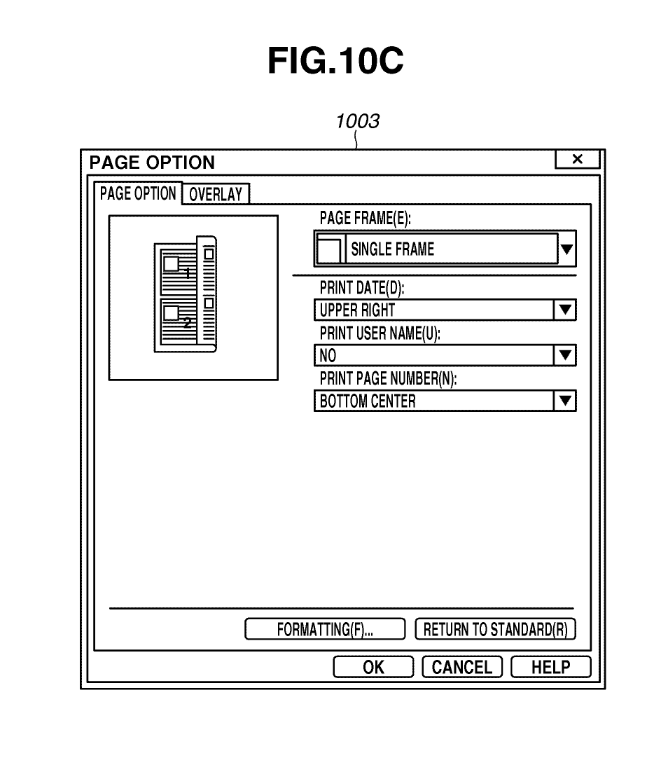

Referring to FIG. 10, the following describes the above-described processing more in detail. FIGS. 10A to 10C are diagrams illustrating an example of the UI. FIG. 10A is a diagram illustrating an example of a registration editing screen 1000 on which “2 pages/sheet”, “Two-sided printing”, and “Color printing” of the print setting information and “Page option” of Setting Item Popup of the action information are assigned to the Collective Setting button 4.

In this case, when the user presses a Collective Setting button 4 (1002) on a main screen 1001 shown in FIG. 10B after registering the settings shown in FIG. 10A, in step S514, “2 pages/sheet”, “Two-sided printing”, and “Color printing” are set in the related setting items in step S505. In addition, because the “Setting item popup” action assigned to the Collective Setting button 4 (1002) is ON, the “Page option” dialog screen 1003 shown in FIG. 10C is displayed in step S512.

FIG. 10 illustrates an example in which the user can not only specify the setting values of the setting items “2 pages/sheet”, “Two-sided printing”, and “Color printing” but also change the setting values of the setting items “Page frame” and “Print date” in the popup format when the user presses the Collective Setting button 4 (1002). In this way, the setting items displayed in the popup format may be a setting item different from the print setting information.

Normally, the user can specify only one item for “Setting item popup”. This is because, when a dialog screen is displayed, only one dialog screen can be displayed because of the limitation on the parent-child relation of the screens (windows).

If the user presses two or more Collective Setting buttons during the processing, the print setting information used for printing is basically overwritten sequentially by the print setting information associated with each Collective Setting button. Therefore, by changing the combination or button-pressing sequence of the Collective Setting buttons, the user can change the print setting information used for printing. Note that this does not apply when the user presses a Collective Setting button to which the “OK press” action is assigned.

For example, assume that “2 pages/sheet” and “Staple ON” are assigned to a Collective Setting button 6 and that “Two-sided printing” and “Staple OFF” are assigned to a Collective Setting button 7. In this case, if the user presses the Collective Setting button 7 after pressing the Collective Setting button 6, “2 pages/sheet”, “Two-sided printing”, and “Staple OFF” are set. On the other hand, if the user presses the Collective Setting button 6 after pressing the Collective Setting button 7, “2 pages/sheet”, “Two-sided printing”, and “Staple ON” are set.

Even when the setting values of print setting items are changed collectively, the user sometimes wants to adjust the setting values more finely. For example, the staple position sometimes needs to be changed depending on whether the orientation of the document is portrait or landscape, and the wording of a stamp is to be changed depending on the type of document.

Specifying the setting values of those related setting items on the screen (detailed setting screen) is cumbersome because, in many cases, the operation involves the switching of the screen (sheet) or the movement into a deeper hierarchical level. Another method is available in which the user registers only the required setting items at a time; however, if there are many combinations, the number of choices increases explosively and the selection becomes still more difficult.

To address those problems, the exemplary embodiment allows the user to assign the “Setting item display” action and the “Setting item popup” action to a Collective Setting button. As a result, the user can specify the detailed setting values of setting items without scrolling the screen, so that efficient setting can be made without unnecessarily increasing the number of registrations of collective setting information.

The user may specify two or more types of action information. For example, when the user presses a Collective Setting button to which “Information acquisition”, “Setting item display”, and “Setting item popup” are assigned, information acquisition is performed. After that, the setting screen for setting the setting values of the specified setting items is displayed on the current screen. In addition, the setting screen for setting the setting values of the specified setting items is displayed in the popup format.

In the configuration described above, when a Collective Setting button is pressed, the user can set the setting values and, at the same time, the action is carried out that is performed after the setting operation, thus increasing user operability.

In the first exemplary embodiment, if the “OK press” action associated with a pressed Collective Setting button is ON, when the Collective Setting button is pressed, the OK press-time processing is always performed. However, when the print setting information is inconsistent, a print matter is not always output exactly as specified by the print setting information.

For example, assume that “Two-sided printing” and “Staple” cannot be specified for a postcard. Also assume that, with “Postcard” specified for the sheet size, the user presses the Collective Setting button 2 (802) to which “4 pages/sheet”, “Two-sided printing”, “Staple ON”, and “Monochromatic printing” are assigned as the print setting information illustrated in the first exemplary embodiment. The result is that a print matter intended by a user is not output because the print operation is performed with “4 pages/sheet” and “Monochromatic printing” set.

To address this problem, the printer driver 303 cancels the “OK press” action in a secondary exemplary embodiment if the registered print setting information cannot be implemented. In cancelling the action, the printer driver 303 may send a message to notify the user about the cancellation. In this exemplary embodiment, the same reference numeral is used for the part corresponding to that of the first exemplary embodiment and the description is omitted.

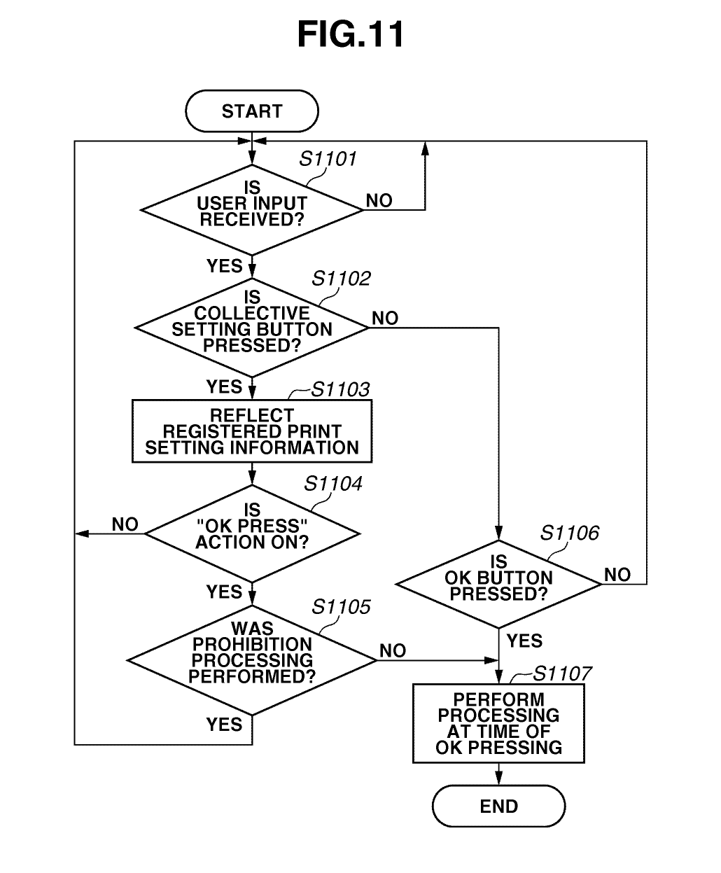

FIG. 11 is a diagram illustrating an example of the flowchart of the print control processing of the printer driver 303.

First, in step S1101, the printer driver 303 determines if an input is received from the user. If an input is received (YES in step S1101), the printer driver 303 performs the processing in step S1102. If an input is not received (NO in step S1101), the printer driver 303 performs the processing in step S1101.

In step S1102, the printer driver 303 determines if the input is the press of a Collective Setting button. If the input is the press of a Collective Setting button (YES in step S1102), the printer driver 303 performs the processing in step S1103. If the input is not the press of a Collective Setting button (NO in step S1102), the printer driver 303 performs the processing in step S1106.

In step S1103, the printer driver 303 reflects the setting values of the print setting information associated with the pressed Collective Setting button, on the current print setting information and, after that, performs the processing in step S1104. In step S1104, the printer driver 303 determines if the “OK press” action is assigned as the collective setting information associated with the pressed Collective Setting button. If the “OK press” action is assigned (YES in step S1104), the printer driver 303 performs the processing in step S1105. If the “OK press” action is not assigned (NO in step S1104), the printer driver 303 performs the processing in step S1101.

In step S1105, the printer driver 303 determines if the prohibition processing was performed in step S1103. The prohibition processing refers to the processing in which, when the setting values that cannot be specified at the same time, for example, “Two-sided printing” and “Postcard”, are set, one of the setting values is cancelled. If the prohibition processing was not performed (NO in step S1105), the printer driver 303 performs the processing in step S1107. If the prohibition processing was performed (YES in step S1105), the printer driver 303 performs the processing in step S1101. The processing insteps S1106 and S1107 is the same as that in steps S515 and S516 in FIG. 5 and, therefore, the description is omitted. Although the printer driver 303 performs the other processing illustrated in FIG. 5, the illustration and the description are omitted here.

In the above configuration, if “OK press” of the action information corresponding to the pressed Collective Setting button is ON but if not all print setting information associated with the pressed Collective Setting button is reflected, the printer driver 303 cancels the processing that would be performed by pressing the Collective Setting button. This allows the user to avoid incomplete processing from being performed without the user knowing it.

Although multiple “Setting item display” actions may be specified in the first exemplary embodiment, the multiple actions, when specified, cannot sometimes be fit on the current screen. In such a case, by continuously pressing the same Collective Setting button, to which the “Setting item display” actions are assigned, the setting values of the setting items can be sequentially switched for display. In this case, the print setting information is updated when the Collective Setting button is pressed for the first time.

In a third exemplary embodiment, the same reference numeral is used for the part corresponding to that of the first exemplary embodiment and the description is omitted.

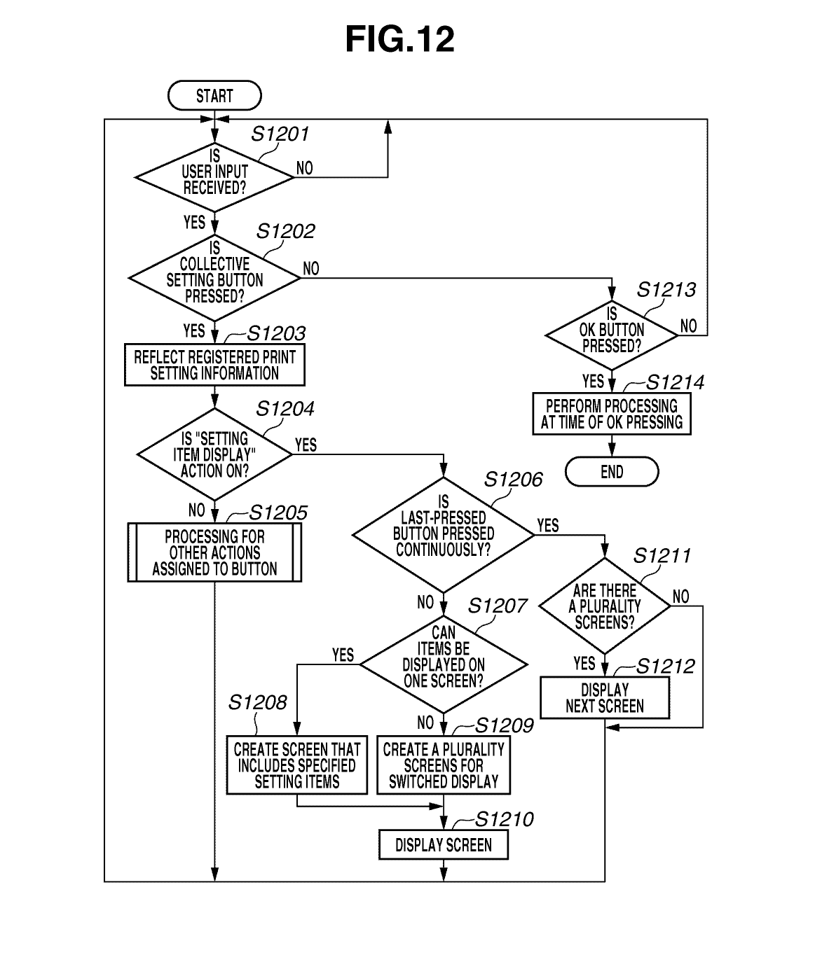

FIG. 12 is a diagram illustrating an example of the flowchart of the print control processing of the printer driver 303.

First, in step S1201, the printer driver 303 determines if an input is received from the user. If an input is received (YES in S1201), the printer driver 303 performs the processing in step S1202. If an input is not received (NO in step S1201), the printer driver 303 performs the processing in step S1201.

In step S1202, the printer driver 303 determines if the input is the press of a Collective Setting button. If the input is the press of a Collective Setting button (YES in step S1202), the printer driver 303 performs the processing in step S1203. If the input is not the press of a Collective Setting button (NO in step S1202), the printer driver 303 performs the processing in step S1213.

In step S1203, the printer driver 303 reflects the print setting information associated with the Collective Setting button, on the current print setting information and, after that, performs the processing in step S1204.

In step S1204, the printer driver 303 determines if the “Print item display” action is assigned to the Collective Setting button. If the “Print item display” action is not assigned to the Collective Setting button (NO in step S1204), the printer driver 303 performs the processing of other actions assigned to the Collective Setting button pressed in step S1202, in step S1205 and then performs the processing in step S1201. The processing for the other actions assigned to the button is the same as that in FIG. 5 and, therefore, the description is omitted. If the “Print item display” action is assigned, the printer driver 303 performs the processing in step S1206.

In step S1206, the printer driver 303 determines if the same Collective Setting button is pressed continuously. If the same Collective Setting button is not pressed continuously (NO in step S1206), in other words, if the Collective Setting button is pressed for the first time, the printer driver 303 calculates the sizes of the specified “Setting items” and, in step S1207, determines if the setting items can be displayed on one screen.

More specifically, if the total value of the heights of all input areas included in the specified setting items is equal to or smaller than the height of the display area of the setting items on the current screen (YES in step S1207), the printer driver 303 determines that the items can be displayed on one screen. If the total value exceeds the height of the display area of the setting items on the current screen (NO in step S1207), the printer driver 303 determines that the setting items cannot be displayed on one screen.

If the setting items can be displayed on one screen (YES in step S1207), the printer driver 303 creates the setting screen for setting the setting values of the specified setting items in step S1208 and then performs the processing in step S1210. If the setting items cannot be displayed on one screen, the printer driver 303 creates a plurality of setting screens (screens for switched display) in step S1209 so that the setting items can be switched for display and then performs the processing in step S1210. The printer driver 303 creates the first screen so that the setting items can be displayed on the current screen. In step S1210, the printer driver 303 displays the screen.

In step S1211, the printer driver 303 determines if a plurality of screens is created. If a plurality of multiple screens is created (YES in step S1211), the printer driver 303 displays the next screen from the prepared screens in step S1212 and then performs the processing in step S1201. If a plurality of screens is not generated (NO in step S1211), the printer driver 303 performs the processing in step S1201.

The processing in steps S1213 and S1214 is the same as that in steps S515 and S516 in FIG. 5 and, therefore, the description is omitted. Although the printer driver 303 performs the other processing illustrated in FIG. 5, the illustration and the description are omitted here.

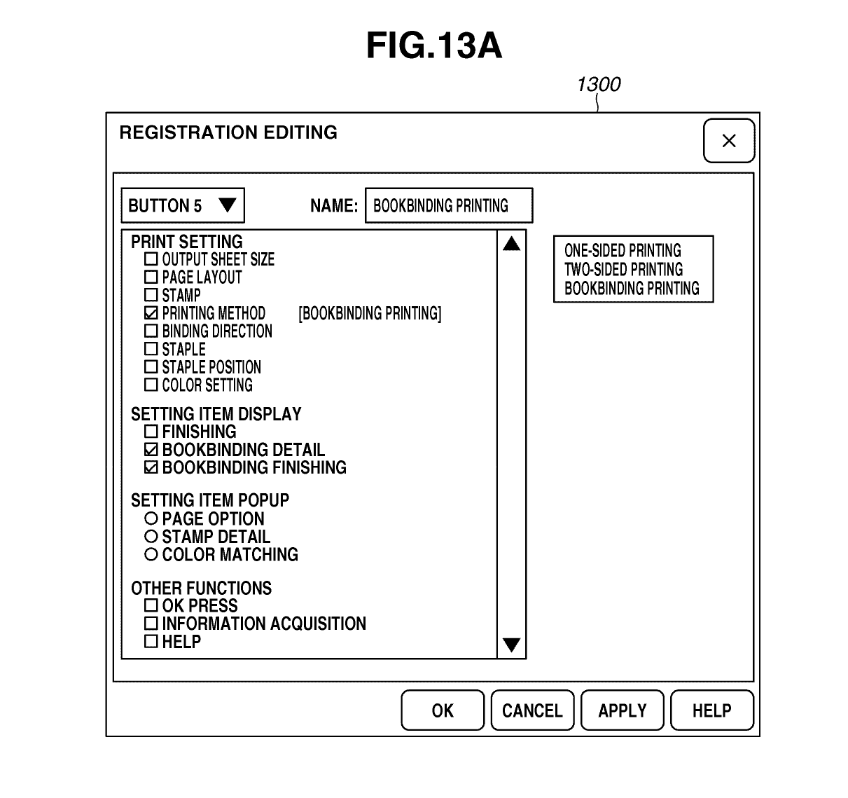

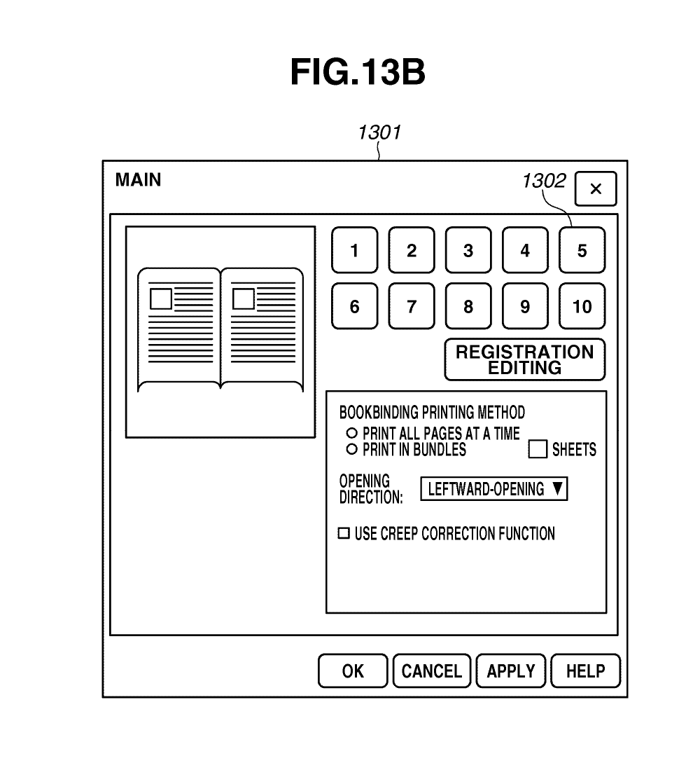

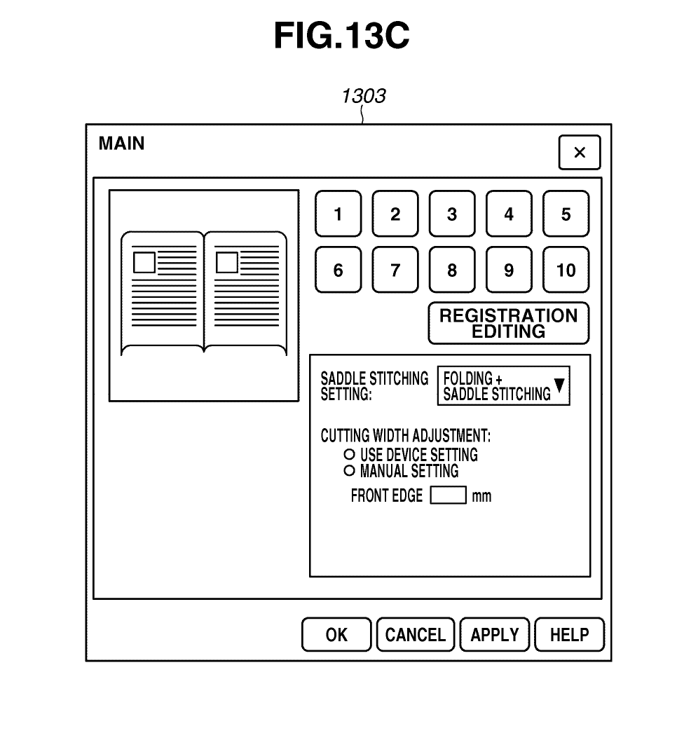

FIG. 13A is a diagram illustrating an example of the UI (registration editing screen 1300) in which “Bookbinding printing” is assigned as the print setting information, and “Bookbinding detail” and “Bookbinding finishing” of Setting Item Display are assigned as the action information of the Collective Setting button 5 (1302). The input area of the setting items of each of “Bookbinding detail” and “Bookbinding finishing” is highly piled, so that they cannot be displayed on one screen at the same time.

This exemplary embodiment addresses this problem as follows. For example, when the user presses the Collective Setting button 5 (1302) on a main screen 1301 shown in FIG. 13B, “Bookbinding printing” is overwritten on the current print setting information. In addition, the setting screen for setting the setting values of the setting items of “Bookbinding detail” is displayed on the current screen. Next, when the user presses the Collective Setting button 5 (1302), the setting screen of “Bookbinding detail” is switched in turn to the screen for setting the values of the setting items of “Bookbinding finishing” on the current screen.

As described above, even when there are many setting items the user wants to display and those setting items cannot be displayed on one screen, a simple user operation, in which the user presses the Collective Setting button several times, switches the screens to be displayed.

In the first exemplary embodiment, the actions assigned to a Collective Setting button are unconditionally executed when the user presses the Collective Setting button. The problem is that an action sometimes does not function expectedly.

One example is that, as described in the second exemplary embodiment, the print setting information is sometimes determined by the “OK press” action when not all print setting information is applied. Another example is that conflict in the print setting information greys out all setting values of displayed setting items and prevents them from functioning properly.

In such a case, according to the fourth exemplary embodiment, the user is notified about a Collective Setting button that does not execute (start) an action completely in advance before the user presses it. In the present exemplary embodiment, the same reference numeral is used for the part corresponding to that of the first exemplary embodiment and the description is omitted.

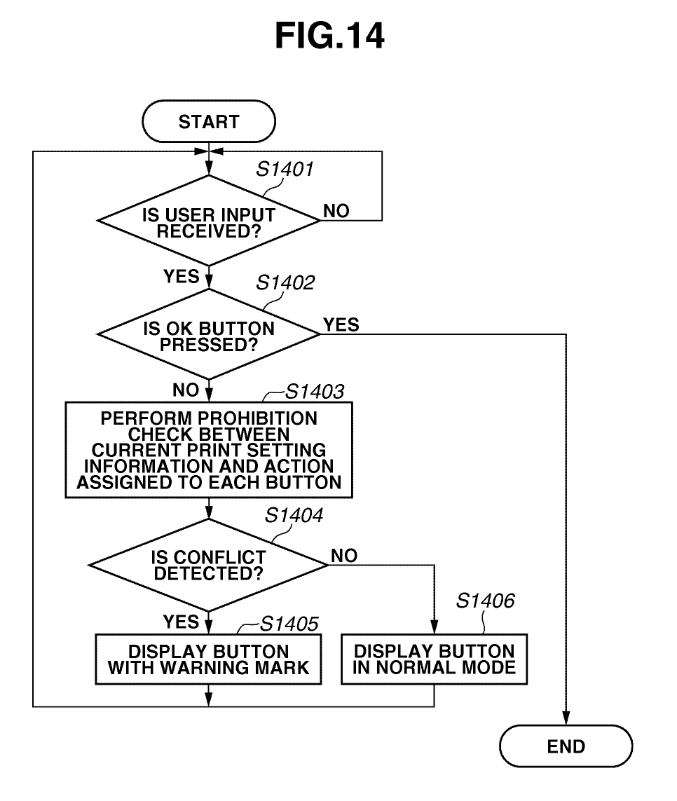

FIG. 14 is a diagram illustrating an example of the flowchart of the print control processing of the printer driver 303.

First, in step S1401, the printer driver 303 determines if an input is received from the user. If an input is received (YES in S1401), the printer driver 303 performs the processing in step S1402. If an input is not received (NO in step S1401), the printer driver 303 performs the processing in step S1401.

In step S1402, the printer driver 303 determines if the input is the press of the OK button. If the input is the press of the OK button (YES in step S1402), the printer driver 303 performs the print processing and then ends the processing. If the input is not the press of the OK button (NO in step S1402), the printer driver 303 performs the processing in step S1403.

In step S1403, the printer driver 303 compares the current print setting information (print setting information before the Collective Setting button is pressed) with the print setting information and the action information associated with each Collective Setting button. After that, in step S1404, the printer driver 303 determines if there is a conflict (state in which an action does not work well because of interference among setting values) that prevents an action from working completely. If there is an action that does not work completely (YES in step S1404), the printer driver 303 performs the processing in step S1405. If all actions work completely (NO in step S1404), the printer driver 303 performs the processing in step S1406.

In step S1405, the printer driver 303 displays a warning indicating that pressing of the Collective Setting button will result in incomplete processing. In step S1406, the printer driver 303 displays the Collective Setting buttons in normal mode. Although the printer driver 303 performs the other processing illustrated in FIG. 5, the illustration and the description are omitted here.

The following describes the above-described processing in more detail using the contents assigned to each of the Collective Setting buttons of the collective setting information 700 illustrated in FIG. 7.

For example, if the current print setting information indicates that the sheet size is “Postcard” to which “Two-sided printing”, “Bookbinding printing”, and “Staple” are not applicable, the setting values of the setting items, which will result in incomplete printing, are determined for the Collective Setting button 2. In addition, because “Bookbinding printing” is invalid for the Collective Setting button 3 and the Collective Setting button 5, the setting screen of “Bookbinding detail” and the setting screen of “Bookbinding finishing” need not be displayed.

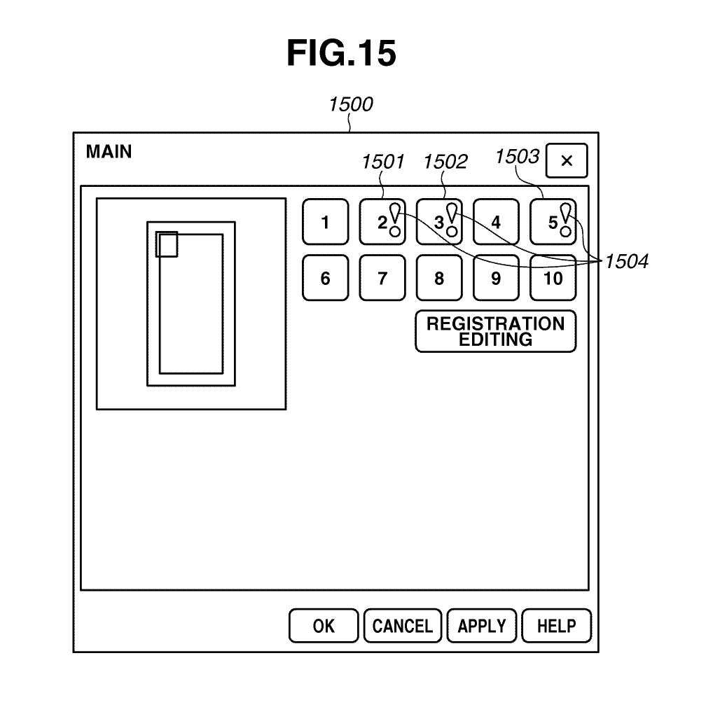

To address this problem, a warning mark (1504) is displayed as shown in FIG. 15 on the Collective Setting button 2 (1501), Collective Setting button 3 (1502), and Collective Setting button 5 (1503), which do not work completely, to notify the user about this condition. Other methods may also be used to notify the user that a Collective Setting button does not work completely, for example, changing the button color or using a tooltip may be used

As described above, the printer driver 303 lets the user know in advance (for example, before pressing a button) that one or more Collective Setting buttons that, even if pressed, do not perform the action completely, thus preventing confusion or unexpected operation. This notification processing (processing in steps S1403 to S1406) may be performed at appropriate timing in the processing described above. For example, the notification processing may be performed when the print setting information and the action information are saved in association with a Collective Setting button.

Although the configurations according to the first exemplary embodiment to the fourth exemplary embodiment are described separately for convenience of description, those configurations may be combined as necessary. The present invention allows the user to change the setting values of print setting items more easily.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-031243 filed Feb. 16, 2011, which is hereby incorporated by reference herein in its entirety.

What is claimed is:

1. An information processing device that has a storage device, the information processing device comprising:
a storing unit configured to store setting information and process information in the storage device in association with a setting button, the setting information indicating setting values of print setting items specified in response to a user operation, and the process information indicating a process assigned in response to the user's operation among a plurality of processes, which may be performed during printing; and
an execution unit configured to update setting information to be used in the printing, with the setting information associated with the setting button and, to perform the process assigned to the process information associated with the setting button, in response to the user's operation of the setting button.

2. The information processing device according to claim 1, further comprising a display device configured to display a screen on which the setting button and a print button are provided, the print button provided for a determination and execution process in which the setting values of the print setting items are determined and the printing is executed,
wherein, when the determination and execution process, in which the setting values of the print setting items are determined and the printing is executed, is assigned to the process information, the execution unit updates the setting information to be used in the printing, with the setting information associated with the selected setting button and closes the screen.

3. The information processing device according to claim 1, further comprising a display device configured to display a screen on which the setting button is provided,
wherein, when a process to display a setting screen of the print setting items on the screen is assigned to the process information, the execution unit updates the setting information to be used in the printing, with the selected setting information and displays the setting screen of the print setting items on the screen.

4. The information processing device according to claim 1, further comprising a display device configured to display a screen on which the setting button is provided,
wherein, when a process to display a setting screen of the print setting items separately from the screen is assigned to the process information, the execution unit updates the setting information to be used in the printing, with the selected setting information and displays the setting screen of the print setting items separately from the screen.

5. The information processing device according to claim 1, further comprising a display device configured to display a screen on which the setting button is provided,
wherein, when a process to display content of help about the printing is assigned to the process information, the execution unit updates the print setting information to be used in the printing, with the selected setting information and displays the content of help about the printing.

6. The information processing device according to claim 2, wherein the execution unit updates the setting information to be used in the printing, with the selected setting information and, if the setting information is determined inconsistent based on determination information used to determine consistency of the updated setting information, does not close the screen.

7. The information processing device according to claim 3, wherein, when the same setting button is operated continuously, the execution unit switches a plurality of the setting screens of the print setting items associated with the setting button, according to the continuous operation.

8. The information processing device according to claim 1, wherein, if the setting information is determined to be inconsistent based on determination information used for consistency determination of the setting information and stored in the storage device, the execution unit informs that inconsistency is detected.

9. The information processing device according to claim 6, the information processing device capable of communicating with a printing device that performs the printing,
wherein, if a process to acquire the determination information from the printing device is assigned to the process information, the execution unit acquires the determination information from the printing device, and
wherein the storing means stores the determination information in the storage device.

10. A printing method for use in an information processing device that has a storage device, the printing method comprising:
storing setting information and process information in the storage device in association with a setting button, the setting information indicating setting values of print setting items specified in response to a user operation, and the process information indicating a process assigned in response to the user's operation among a plurality of processes, which may be performed during printing; and
in response to the user's operation of the setting button, updating setting information to be used in the printing with the setting information associated with the setting button and performing the process assigned to the process information associated with the setting button.

11. A non-transitory computer-readable storage medium storing a control program, which when loaded into a computer and executed performs a printing method for use in an information processing device that has a storage device, the printing method comprising:
a storing unit configured to store setting information and process information in the storage device in association with a setting button, the setting information indicating setting values of print setting items specified in response to a user operation, and the process information indicating a process assigned in response to the user's operation among a plurality of processes, which may be performed during printing; and
an execution unit configured to update setting information to be used in the printing with the setting information associated with the setting button and, to perform the process assigned to the process information associated with the setting button, in response to the user's operation of the setting button.

12. The computer-readable storage medium according to claim 11, wherein the printing method further comprises a display device configured to display a screen on which the setting button and a print button are provided, the print button provided for a determination and execution process in which the setting values of the print setting items are determined and the printing is executed, and
wherein, when the determination and execution process, in which the setting values of the print setting items are determined and the printing is executed, is assigned to the process information, the execution unit updates the setting information to be used in the printing, with the setting information associated with the selected setting button and closes the screen.

13. The computer-readable storage medium according to claim 11, wherein the printing method further comprises a display device configured to display a screen on which the setting button is provided
wherein, when a process to display a setting screen of the print setting items on the screen is assigned to the process information, the execution unit updates the setting information to be used in the printing, with the selected setting information and displays the setting screen of the print setting items on the screen.

14. The computer-readable storage medium according to claim 11, wherein the printing method further comprises a display device configured to display a screen on which the setting button is provided, and
wherein, when a process to display a setting screen of the print setting items separately from the screen is assigned to the process information, the execution unit updates the setting information to be used in the printing, with the selected setting information and displays the setting screen of the print setting items separately from the screen.

15. The computer-readable storage medium according to claim 11, wherein the printing method further comprises a display device configured to display a screen on which the setting button is provided, and
wherein, when a process to display content of help about the printing is assigned to the process information, the execution unit updates the print setting information to be used in the printing, with the selected setting information and displays the content of help about the printing.

16. The computer-readable storage medium according to claim 11, wherein the execution unit updates the setting information to be used in the printing, with the selected setting information and, if the setting information is determined inconsistent based on determination information used to determine consistency of the updated setting information, does not close the screen.

17. The computer-readable storage medium according to claim 11, wherein when the same setting button is operated continuously, the execution unit switches a plurality of the setting screens of the print setting items associated with the setting button, according to the continuous operation.

18. The computer-readable storage medium according to claim 11, wherein if the setting information is determined to be inconsistent based on determination information used for consistency determination of the setting information and stored in the storage device, the execution unit informs that inconsistency is detected.

19. The computer-readable storage medium according to claim 16, wherein the information processing device is capable of communicating with a printing device that performs the printing,
wherein, if a process to acquire the determination information from the printing device is assigned to the process information, the execution unit acquires the determination information from the printing device, and
wherein the storing means stores the determination information in the storage device.
